(19) United States
(12) Patent Application Publication
(10) Pub. No.: US 2025/0117809 A1
(43) Pub. Date: Apr. 10, 2025

(54) METHOD FOR PROVIDING CAREER VERIFICATION INFORMATION AND ELECTRONIC DEVICE SUPPORTING THE SAME

(71) Applicant: KAKAO CORP., Jeju-si (KR)

(72) Inventors: Hyung Seop LIM, Seongnam-si (KR); Hyun Ji IM, Seongnam-si (KR)

(21) Appl. No.: 18/905,151

(22) Filed: Oct. 3, 2024

(30) Foreign Application Priority Data
Oct. 6, 2023 (KR) 10-2023-0133320

(51) Int. Cl. G06Q 30/018; G06Q 10/0631; G06Q 10/1053

(52) U.S. Cl. CPC G06Q 30/018; G06Q 10/063112; G06Q 10/1053

(57) ABSTRACT

Disclosed is a method for providing career verification information by a server, the method including: receiving a career verification request for a user from a user terminal; in response to the career verification request, identifying at least one certification data including career information of the user; identifying career information for the user based on the at least one identified certification data; and in response to the identified career information comprising a plurality of career information, providing career verification information for the user to the user terminal so that user interfaces corresponding to each of the plurality of career information are displayed distinctly on the user terminal.

### BACKGROUND

### Technical Field

The present disclosure relates to a method of verifying a user's career and providing verified career information of the user, and an electronic device supporting the same.

### Description of Related Technology

When an individual needed to provide proof of his or her university education for purposes such as applying to graduate school, it was common for the individual to request this proof directly and offline from the university's admissions office. However, recently, certificates can be issued through university certification issuance websites that act as intermediaries for issuing graduation certificates. Furthermore, when an individual needs to provide proof of employment history for purposes such as applying for a job, it was typical to contact the previous employer directly and offline to obtain this proof. Recently, however, government websites have begun providing documents that verify an individual's employment, such as the Certificate of Eligibility Record for Health Insurance and the National Pension Subscription Certificate.

### SUMMARY

The present disclosure provides a method for verifying a user's career based on various certification data and providing a user interface corresponding to the verified career information of the user, as well as an electronic device that supports the method.

In one general aspect, there is provided a method for providing career verification information by a server, the method including: receiving a career verification request for a user from a user terminal; in response to the career verification request, identifying at least one certification data including career information of the user; verifying career information for the user based on the at least one identified certification data; and in response to the verified career information comprising a plurality of career information, providing career verification information for the user to the user terminal so that user interfaces corresponding to each of the plurality of career information are displayed distinctly on the user terminal.

The at least one certification data may be data including at least one of the user's employment information, income information, and company information.

The career verification information for the user may include at least one of the following: name information, work experience information, employment status information, and job position information of the user.

The method may further include: identifying updates to the career information for the user; and providing career update verification information for the user to the user terminal so that a user interface corresponding to the updated career information is displayed on the user terminal.

The method may further include: generating associated verification information for the user based on the career information for the user; and providing the generated associated verification information to the user terminal.

The generating of the associated verification information for the user may include:
receiving a request to generate associated verification information for the user from the user terminal; categorizing the career information for the user according to preset categories; and generating associated verification information for the user based on the categorized career information.

The generating of the associated verification information for the user may include:
identifying additional requirement information for generating the associated verification information; transmitting the identified additional requirement information to the user terminal; and in response to receiving the identified additional requirement information from the user terminal, generating associated verification information for the user.

The additional requirements information may include information that certifies at least one of educational background information, license information, and facility access permit information for the user.

In another aspect, there is provided a server providing career verification information, the server includes a memory storing instructions, and a processor configured to execute the instructions to: receive a career verification request for a user from a user terminal; in response to the career verification request, identify at least one certification data including career information of the user; verify career information for the user based on the at least one identified certification data; and in response to the verified career information comprising a plurality of career information, provide career verification information for the user to the user terminal so that user interfaces corresponding to each of the plurality of career information are displayed distinctly on the user terminal.

In yet another aspect, there is provided a method of providing career verification information by a user terminal, the method including: transmitting a career verification request for a user to a server; receiving career verification information for the user from the server, wherein the career verification information is generated based on at least one certification data including career information for the user; and displaying a user interface corresponding to the received career verification information on a screen of the user terminal, wherein when the career information comprises a plurality of career information, user interfaces corresponding to each of the plurality of career information are displayed distinctly on the user terminal.

The at least one certification data may be data including at least one of the user's employment information, income information, and company information.

The career verification information for the user may include at least one of the following: name information, work experience information, employment status information, and job position information of the user.

The method may further include: identifying updates to the career information for the user; and displaying a user interface corresponding to the updated career information on the screen of the user terminal.

The method may further include: requesting to generate associated verification information for the user from the server; receiving associated verification information from the server; and displaying a user interface corresponding to the received associated verification information on the screen of the user terminal.

The receiving of the associated verification information from the server may include: receiving additional requirement information for generating the associated verification information from the server; and transmitting the additional requirement information to the server

The additional requirements information may include at least one of educational background information, license information, and facility access permit information for the user.

In yet another aspect, there is provided a user terminal providing career verification information, the user terminal including a memory storing instructions, and a processor configured to execute the instructions to: transmit a career verification request for a user to a server; receive career verification information for the user from the server, wherein the career verification information is generated based on at least one certification data including career information for the user; and display a user interface corresponding to the received career verification information on a screen of the user terminal, wherein when the career information comprises a plurality of career information, user interfaces corresponding to each of the plurality of career information are displayed distinctly on the user terminal.

### BRIEF DESCRIPTION OF THE DRAWINGS

FIG. 1 is a diagram illustrating an example of a network environment according to an embodiment of the present disclosure.

FIG. 2 is a flowchart illustrating an example in which a server provides career verification information, according to an embodiment of the present disclosure.

FIGS. 3A and 3B are diagrams illustrating examples in which a user terminal requests career verification information from an application according to an embodiment of the present disclosure.

FIGS. 4A and 4B are diagrams illustrating an example in which a user terminal displays a

user interface corresponding to career verification information, according to an embodiment of the present disclosure.

FIGS. 5A to 5C are diagrams illustrating an example of a user terminal displaying a user interface corresponding to career verification information, according to an embodiment of the present disclosure.

FIG. 6 is a diagram illustrating an example of generating associated verification information according to an embodiment of the present disclosure.

### DETAILED DESCRIPTION

Description will now be given in detail according to exemplary embodiments disclosed herein, with reference to the accompanying drawings. For the sake of brief description with reference to the drawings, the same or equivalent components may be provided with the same or similar reference numbers, and description thereof will not be repeated. In addition, in the following description of the embodiments, a detailed description of known functions and configurations incorporated herein will be omitted when it may impede the understanding of the embodiments.

While terms including ordinal numbers, such as “first” and “second,” etc., may be used to describe various components, such components are not limited by the above terms. The above terms are used only to distinguish one component from another.

The singular forms are intended to include the plural forms as well, unless the context clearly indicates otherwise.

In this application, the described steps may be carried out in any sequence, except in cases where a clearly defined cause-and-effect relationship necessitates a specific order.

It will be further understood that the terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

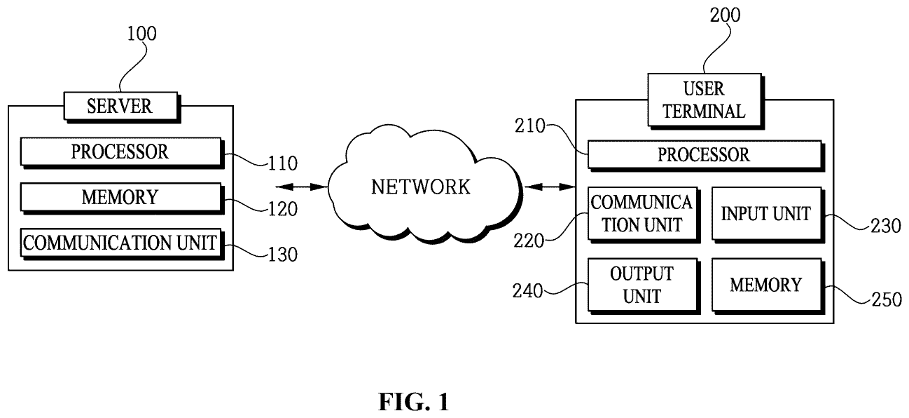

FIG. 1 is a diagram illustrating an example of a network environment according to an embodiment of the present disclosure.

Hereinafter, the present disclosure will be described with reference to the attached drawings.

According to various embodiments, a server 100 may be connected to a user terminal 200 over a network. Communication schemes for a network are not limited. The communication schemes may include not only a communication scheme to utilize a telecommunication network (for example, a mobile communication network, wired Internet, wireless Internet, and a broadcast network), but also a short-range radio communication scheme.

According to various embodiments of the present disclosure, the server 100 may be implemented as a computer device or a plurality of computer devices providing commands, codes, files, content, services, etc. In one embodiment, the server 100 may be an electronic device capable of transmitting and receiving information through communication with the user terminal 200 over a network. Although the server 100 is described as a single server for convenience of explanation, the server 100 may be composed of a plurality of electronic devices each providing a different function or service.

According to various embodiments, when the server 100 requires the user terminal 200 to perform a function or service automatically or upon request, the user terminal 200 may request that the server 100 perform at least some of the functions associated therewith instead of or in addition to performing the function or service by itself.

The server 100 may execute a requested function or additional function and transmit a result to the user terminal 200. The user terminal 200 may provide a requested function or service by processing the received result either as is or with additional processing. For example, cloud computing, distributed computing, or client-server computing technologies may be used.

The server 100 may include a processor 110, a communication unit 120, and a memory 130. The processor 110 may control the overall operation of the communication unit 120 and the memory 130. According to various embodiments of the present disclosure, the communication unit 120 may communicate with the electronic device 100 over a network in a wired or wireless manner. The memory 130 functions as a storage medium and may store multiple applications running on the server 100, as well as data and commands required for the operation of the server 100. In one embodiment, the memory 130 may be provided in the form of any of various hardware storage devices such as a read-only memory (ROM), a random-access memory (RAM), a flash drive, a hard drive, etc., or may be provided in the form of web storage.

According to various embodiments, the processor 110 may provide a functionality or user interface that allows the user terminal 200 to download an application offering various functions via the server 100 or an external server (e.g., an online platform, an external application download server, etc.). In one embodiment, the application may include an application specified according to the attributes of the server 100 or an application received from the server 100. For example, the application may include a preloaded application or a third-party application available for download from the server 100.

According to various embodiments, if a user account on a user terminal 200 that has downloaded an application offering various functions (e.g., a messenger application, an application providing financial information, an application offering verification of educational background and/or work experience, etc.) requests to join as a member, the processor 110 may provide a membership registration user interface that offers an ID, password, verification, and other details. After the user account has joined the application as a member, the processor 110 may provide relevant user interfaces that enable a user account to perform functions such as logging in and managing the account.

According to various embodiments, the processor 110 may receive a career verification request for a user from the user terminal 200. In one embodiment, the processor 110 may receive a career verification request for the user from the user terminal 200 which has downloaded an application that provides a career verification functionality. For example, the processor 110 may receive, from the user terminal 200, a career verification request for a user who has completed identity authentication.

Here, the identity authentication for the user may be performed by entering the ID and password that the user has registered with the application on the user terminal 200 (e.g., a messenger application, an application that provides work experience verification, etc.). In another embodiment, the identity authentication for the user may be performed through SMS verification, where an authentication server (e.g., the server 100 or an external server) sends a one-time authentication code to the user terminal 200 upon request and then the authentication server authenticates the user upon receiving the code from the user terminal 200. In further embodiments, the identity authentication for the user may be performed through methods such as entering electronic certificates issued by national or public institutions (e.g., accredited certificates, joint certificates, etc.), resident registration number or social security number (SSN), email verification, biometric authentication, i-PIN authentication, or by submitting a passport copy to the authentication server.

According to various embodiments, the processor 110 may verify at least one certification data including career information for the user in response to the career verification request from the user terminal 200.

In one embodiment, in response to a career verification request from a user who has completed identity authentication, the processor 110 may request certification data for the user from an external server (e.g., a national agency website, a public institution website, a private data management website, etc.). The processor 110 may receive certification data for the user from the external server. For example, the processor 110 may identify documents such Certificate of Eligibility Record for Health Insurance, Certificate of Eligibility for Health Insurance, the National Pension Subscription Certificate, Certificate of Income, etc. from national agency websites and/or public institution websites to verify the user's career.

In another example, the processor 110 may identify W-2 forms (Wage and Tax Statements) from the Internal Revenue Service (IRS) website or an external server to verify the user's career. In yet another example, the processor 110 may identify pay stubs, bank transaction records showing received salaries, or employment history from national institutions or private servers in the U.S.

According to various embodiments, based on at least one identified certification data, the processor 110 may provide career verification information for the user to the user terminal 200. In one embodiment, the processor 110 may identify the user's legal name, employer information, job position information, and duration of employment based on Certificate of Eligibility Record for Health Insurance or W-2 forms. For example, the processor 110 may identify data that ‘Peter Kim,’ who downloaded the application, has worked for 1.5 years at ‘A IT Company’, which is the current employer, based on the Certificate of Eligibility Record for Health Insurance. The processor 110 may provide a relevant functionality or user interface to the user terminal 200 to display identified career verification information (e.g., Peter Kim's work experience information).

Here, the user interface corresponding to the career verification information may be designed in various forms, such as a card-style graphical user interface and a flat design user interface, as displayed through an application on the user terminal 200.

According to various embodiments, if the career information for the user includes a plurality of career information, the processor 110 may provide a functionality so that each career information is displayed distinctly on the user terminal 200. In one embodiment, the processor 110 may identify that ‘Sera Kim,’ who has downloaded an application, has worked for 3 years at the previous employer, ‘B IT Company,’ and for 5 years at the current employer, ‘A IT Company,’ based on U.S. W-2 forms. The processor 110 may provide a functionality or user interface for the user terminal 200 to display separate user interfaces corresponding to each of the previous and current employers.

In another embodiment, the processor 110 may provide a functionality or user interface so that career verification information is displayed as part of profile information for a user account on a messaging application on the user terminal 200. For example, the processor 110 may provide a functionality or user interface that allows other user terminals to identify career verification information (e.g., current employer information and previous employer information) and educational background information of the user account on the messenger application. The user terminal 200 may configure the scope of career information, educational background information, certification information, and other data to be disclosed to other user terminals.

According to various embodiments, the user terminal 200 may include at least one of the following: a smartphone, a tablet personal computer (tablet PC), a mobile phone, a video phone, an e-book reader, a desktop personal computer (desktop PC), a laptop personal computer (laptop PC), a netbook computer, a workstation, a server, a personal digital assistant (PDA), a portable multimedia player (PMP), an MP3 player, a mobile medical device, a camera, and a wearable device.

Referring to FIG. 1, the user terminal 200 may include a processor 210, a communication unit 220, an input unit 230, an output unit 240, and a memory 250, according to various embodiments. In one embodiment, at least one of the components of the user terminal 200 may be omitted or another component may be additionally provided.

The processor 210 may control a number of hardware or software components connected to the processor 210 by running an operating system or application, and may perform various data processing and computations. The processor 210 may execute an application by controlling the overall operation of the communication unit 220, the input unit 230, the output unit 240, and the memory 250.

The communication unit 220 may establish communication between the user terminal 200 and an external electronic device. For example, the communication unit 220 may be connected to a network through wireless or wired communication to communicate with an external electronic device (e.g., an external server) or the server 100.

The input unit 230 may serve as an interface for transmitting commands or data received from the user or other external devices to other components of the user terminal 200. Additionally, the input unit 230 may output commands or data received from other components of the user terminal 200 to the user or other external devices. For example, the input unit 230 may include a touchscreen module, keyboard, mouse, buttons, camera, stylus, microphone, etc.

The user terminal 200 may receive a user's interaction through the input unit 230. An interaction refers to inputting information that reflects the user's selection or intention by manipulating the input unit 230 on the user terminal 200. For example, the interaction may include a touch on a touchscreen, a mouse click, keyboard typing, sound input through a microphone, image capture by a camera, and motion recognition by a motion sensor.

The output unit 240 may output various information. The output unit 240 may be a display, a touch screen, a speaker, a vibration generator, a tactile generator, etc. For example, the output unit 240 may provide various types of content to the user (e.g., text, images, videos, icons, or symbols). According to various embodiments, the output unit 240 may be a device (e.g., Bluetooth earphones) connected to the electronic device 200 via wired or wireless communication (e.g., near-field communication such as Bluetooth) to receive and output signals.

The memory 250 functions as a storage medium and may store a number of application programs running on the user terminal 200, as well as data and commands for operating the user terminal 200. Such memory may be provided in various storage device forms, such as ROM, RAM, flash drives, hard drives, or in the form of web storage.

According to various embodiments, the user terminal 200 may include an operating system that controls resources related to the user terminal 200 and/or various applications running on the operating system. For example, the user terminal 200 may include one or more applications that perform functions such as home, dialer, SMS/MMS, browser, camera, and calendar. According to various embodiments, the applications may include designated applications according to the attributes of the server 100 or applications received from the server 100. For example, the application may include a preloaded application or a third-party application available for download from the server 100.

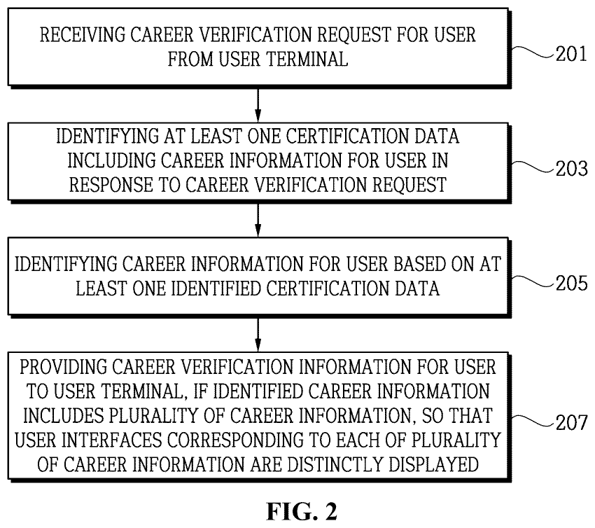

FIG. 2 is a flowchart illustrating an example in which the server 100 provides career verification information, according to an embodiment of the present disclosure.

In operation 201, a server 100 may receive a career verification request for a user from a user terminal 200.

According to various embodiments, the server 100 may receive, from the user terminal 200, a career verification request for a user who has completed identity authentication. In one embodiment, the server 100 may determine whether the user, who is the subject of the career verification request, has completed the identity authentication. For example, the server 100 may determine whether the entity requesting career verification is the user by using various identity authentication techniques (e.g., SMS verification, accredited certificates, joint certificates, biometric authentication, resident registration number verification, social security number verification, etc.). The server 100 may proceed with career verification only if the user, who is the subject of the career verification request, has completed identity authentication using various identity authentication techniques.

In one embodiment, if the user terminal 200 which made the career verification request has not completed identity authentication, the server 100 may halt the process of providing career verification information for the user. In order to generate career verification information, the server 100 may provide a relevant functionality or user interface so that a popup window including a message requiring the completion of identity authentication is displayed on the user terminal 200.

In another embodiment, if the entity requesting the user's career verification is a third party (e.g., an employer, a bank, an online platform requiring predetermined work experience, etc.) rather than the user terminal 200, the server 100 may send a message to the user terminal 200 to inform the user terminal 200 of the third party's career verification request. If the server 100 receives an input or response message from the user terminal 200 allowing the third party to proceed with career verification, the server 100 may provide the third party with career verification for the user and career verification information.

Referring to operation 203, the server 100 may identify at least one certification data including the career information of the user in response to the career verification request from the user terminal 200.

According to various embodiments, the server 100 may identify various certification data to generate career verification information for the user. In one embodiment, the server 100 may request career-related information about the user (e.g., previous employer information, current employer information, duration of employment, etc.) from national institutions, public agencies, or certified private entities that provide various certification data. For example, certification data for generating career verification information may include data including at least one of employment information, income information, and company information for the user.

The server 100 may receive career-related information about the user from the national institutions, the public agencies, and/or the certified private entities. Here, the national institutions, the public agencies, and the certified private entities may provide various certification data about authenticated users to the server 100 based on pre-established agreements, contracts, or predefined integrations with the server 100.

For example, the server 100 may identify public data received from the national or public institutions (e.g., Certificate of Eligibility Record for Health Insurance, Certificate of Eligibility for Health Insurance, the National Pension Subscription Certificate, Certificate of Income) to identify the user's career information. In another example, the server 100 may identify information about a company's business name, registration details, etc., through integration with public data portals or the Financial Supervisory Service website.

Here, the Certificate of Eligibility Record for Health Insurance/Certificate of Eligibility for Health Insurance and the National Pension Subscription Certificate are public data issued by national or public institutions in South Korea and may include information about an individual's previous and current employers, such as the start and end dates of employment at each employer. In addition, the Certificate of Income is public data issued by national or public institutions in South Korea and may include information about a corporation's name, business number, income amount, etc. Furthermore, the public data portals are websites that provide public data created, acquired, and managed by public institutions, and the public data portals may provide information about business names, registration numbers, industry types, etc. The Financial Supervisory Service, as a public institution, may provide information about business registration numbers, KOSDAQ-listed companies, etc.

In another embodiment, the server 100 may identify W-2 forms (Wage and Tax Statements) from the Internal Revenue Service (IRS) website or other U.S. public institutions, which proves the user's career. In another example, the server 100 may identify pay stubs, bank transaction records showing received salaries, or employment history from national institutions or private servers in the U.S.

In operation 205, the server 100 may identify career information for the user based on at least one identified certification data.

In one embodiment, the server 100 may identify the user's career information based on certification data received from national institutions, public agencies, and certified private entities. This career information may include at least one of the following: the user's name information, work experience information, employment status information, and job position information.

In one embodiment, the user's name information may be the user's legal name of the user, rather than a name of the user account registered with the application on the user terminal 200 or a nickname created by the user terminal 200. The user's work experience information may include details about previous workplaces, duration of employment, job titles and roles, and/or skills developed during the user's career (e.g., capabilities and skills acquired). The user's employment status information may include the current employment status (e.g., whether the user is currently employed, and the resignation date if applicable), duration of employment, department or team, salary, and/or benefits. The user's job position information may include details about current or previous job positions, job responsibilities, and/or work capabilities.

In operation 207, when the identified career information includes a plurality of career information, the server 100 may provide career verification information for the user to the user terminal 200 so that user interfaces respectively corresponding to the plurality of career information are displayed on the user terminal 200.

According to various embodiments, the server 100 may provide a functionality or user interface so that a user interface corresponding to the career verification information is displayed on the user terminal 200. Here, the user interface may be a graphical user interface that includes the career verification information for the user (e.g., the user's name information, work experience information, employment status information, job position information, etc.).

In one embodiment, the server 100 may provide the career verification information to the user terminal 200, and may provide a relevant functionality so that a relevant user interface is displayed through an application downloaded by the user terminal 200 (e.g., a messenger application or an application that provides career verification request functionality). In another embodiment, the server 100 may generate a user interface corresponding to the career verification information and transmit the generated user interface to the user terminal 200. The user terminal 200 may display the user interface received from the server 100 on the screen through an application.

According to various embodiments, when the career information for the user includes a plurality of career information, the server 100 may provide a relevant functionality so that each career information is distinctly displayed on the user terminal 200. In one embodiment, the server 100 may identify the plurality of career information, such as previous employer information, current employer information, employment duration at each employer, job position information at each employer, salary, etc. based on various certification data.

According to various embodiments, the server 100 may provide a relevant functionality so that a user interface corresponding to each identified employer information is displayed separately on the user terminal 200. For example, if ‘Peter Kim’ has worked for 2 years at ‘First IT Company’ and then moved to ‘Second IT Company’ for 3 years, the server 100 may provide a relevant functionality so that user interfaces for ‘First IT Company’ and ‘Second IT Company’ are displayed separately on the user terminal 200.

According to various embodiments, the server 100 may identify updates to the user's career information. In one embodiment, after receiving a career verification request for the user from the user terminal 200, the server 100 may receive an additional career verification request for the user from the user terminal 200. The server 100 may identify updates related to changes in employer information, such as job transition and salary, based on at least one certification data. For example, if ‘Sarah Lee’ has moved from ‘First Platform Company’ to ‘First Cosmetics Company’ after working for 3 years at ‘First Platform Company,’ the server 100 may identify the updated career information for ‘Sarah Lee’ at ‘First Cosmetics Company.’

In another embodiment, after receiving a career verification request for the user from the user terminal 200, the server 100 may identify updates to the user's career information periodically (e.g., quarterly, annually, or according to a period set by the user terminal 200), even if no additional verification request is received from the user terminal 200.

In one embodiment, the server 100 may provide career update verification information to the user terminal 200 so that a user interface corresponding to the updated career information is displayed on the user terminal 200. For example, if the user ‘Sarah Lee’ has moved from ‘First Platform Company’ to ‘First Cosmetics Company’ after working for 3 years at ‘First Platform Company,’ the server 100 may identify ‘First Platform Company’ as the previous employer and ‘First Cosmetics Company’ as the current employer. The server 100 may then provide career update verification information so that user interfaces respectively corresponding to ‘First Platform Company’ and ‘First Cosmetics Company’ are displayed separately on the user terminal 200.

Here, the user interfaces respectively corresponding to the user's previous and current employers may be graphical user interfaces that distinguish between the previous and current employers. For example, the user interfaces respectively corresponding to the previous and current employers may be distinguished by using different colors, fonts, sizes, etc. In another example, the user interfaces respectively corresponding to the previous and current employers may be configured as distinct card-style graphical user interfaces.

According to various embodiments, the server 100 may generate associated verification information for the user based on the career information. In one embodiment, the server 100 may categorize the career information according to preset career categories (e.g., preset industry classifications or preset sector standards). For example, the server 100 may categorize the user's current and previous employer information into relevant industries.

Here, the preset career categories may include industries such as IT (e.g., software developers, network engineers, data analysts, security specialists), healthcare and medical (e.g., doctors, nurses, dentists, health policy researchers), finance (e.g., bankers, financial analysts, accountants, financial planners), education (e.g., teachers, librarians, education managers), entertainment (e.g., actors, musicians, film directors, producers), engineering (e.g., electrical engineers, mechanical engineers, environmental engineers), marketing and advertising (e.g., marketers, advertising agency staff, brand managers), and law (e.g., patent attorneys, judges, lawyers).

In one embodiment, the server 100 may generate associated verification information based on the categorized career information. For example, if the server 100 identifies, based on at least one certification data, that the user has been employed for 3 years at ‘First IT Company’ after 2 years at ‘Second IT Company’ and 3 years at ‘Third IT Company,’ the server 100 may generate associated verification information such as ‘8+Years IT Industry career verification.’ In another example, if the server 100 verifies, based on at least one certification data, that the user has been employed for 2 years at ‘First Media Outlet,’ the server 100 may generate associated verification information such as ‘media industry employment verification’ or ‘major media outlet employment verification.’

According to various embodiments, the server 100 may receive a request to create associated verification information from the user terminal 200. In one embodiment, the server 100 may identify additional requirement information for creating the requested associated verification information. For example, the server 100 may identify ‘currently employed at a media company’ and ‘journalist registration card’ as requirements for generating associated verification information such as ‘major media company journalist verified.’ In another example, the server 100 may identify ‘experience at a law firm and/or in-house’ and ‘lawyer license’ as requirements for generating associated verification information such as ‘8 years of experience as a lawyer.’

According to various embodiments, the server 100 may transmit additional requirement information necessary for generating associated verification information requested by the user terminal 200. In one embodiment, the server 100 may request the user terminal 200 to submit data that certifies at least one of the user's educational background information, license information, or facility access permit information.

For example, if the server 100 receives a request from the user terminal 200 to generate associated verification information such as ‘major media outlet journalist verification,’ the server 100 may identify facility access permit information, such as a ‘journalist registration card,’ as an additional requirement based on the certification data for the user. The server 100 may request the submission of the ‘journalist registration card’ from the user terminal 200. In another example, if a request to generate associated verification information such as ‘10-year of experience as a layer verified’ is received, the server 100 may identify the additional requirement information, such as the ‘lawyer license,’ based on the certification data for the user. The server 100 may request the submission of the ‘lawyer license’ from the user terminal 200.

According to various embodiments, the server 100 may generate associated verification information based on additional requirement data received from the user terminal 200 and career information for a user (e.g., previous employer information, current employer information, etc.). In one embodiment, the server 100 may receive additional requirement information such as educational background information, license information, and/or facility access permit information from the user terminal 200. For example, the server 100 may receive a university graduation certificate, a patent attorney certificate, a journalist registration card, etc. which are required for generating associated verification information. In such an example, the server 100 may generate associated verification information such as verification of ‘5 years of experience as a patent attorney verified’ based on the patent attorney certificate and the certification data indicating 5 years of employment at ‘First Patent Law Firm.’

According to various embodiments, the server 100 may provide the generated associated verification information to the user terminal 200. In one embodiment, the server 100 may provide a relevant functionality or user interface so that a user interface corresponding to the generated associated verification information is displayed on the user terminal 200. For example, the server 100 may transmit associated verification information such as ‘5-years of experience as a patent attorney verified,’ ‘major media outlet journalist verified,’ and ‘8 years of experience as a lawyer verified’ to the user terminal 200.

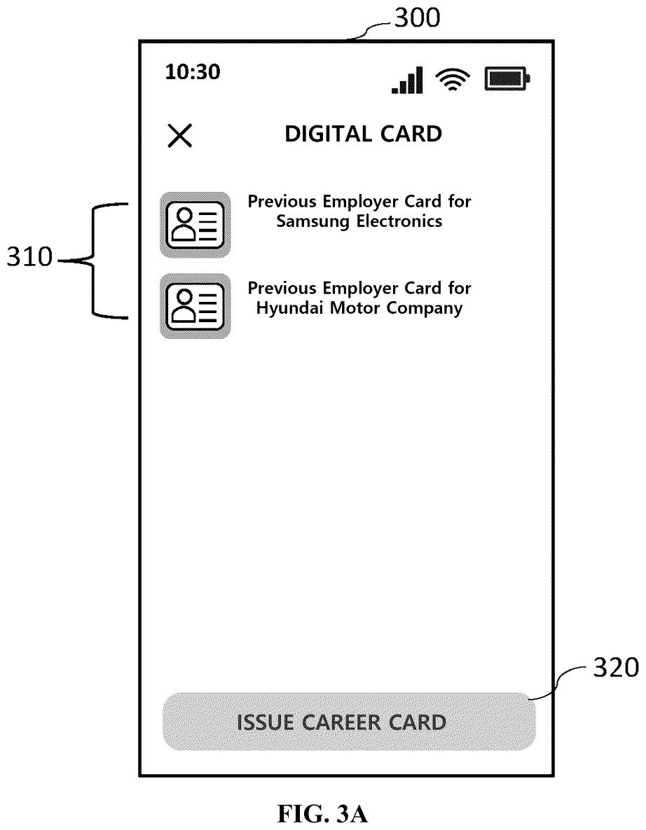

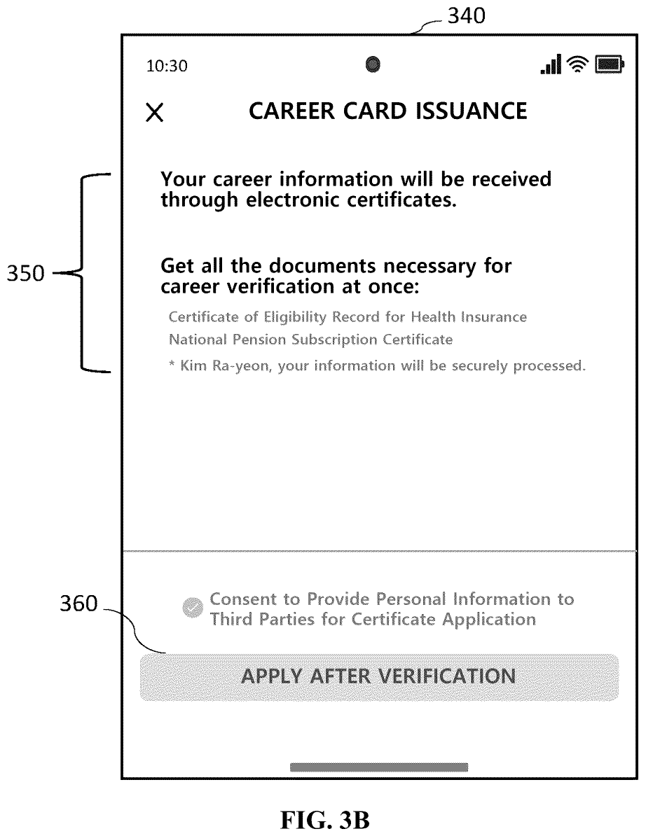

FIGS. 3A and 3B are diagrams illustrating an example of a user terminal 200 requesting career verification information in an application according to an embodiment of the present disclosure.

Referring to FIG. 3A, the user terminal 200 may display a user interface corresponding to a user's career information on a screen of the user terminal 200. In one embodiment, the user terminal 200 may download an application, which provides a user interface corresponding to the user's career information, from a server 100 or an external server (e.g., an online platform, an external application download server, etc.).

In one embodiment, the user terminal 200 may display a digital card user interface 300 included in the application on the screen of the user terminal 200. Here, the digital card user interface 300 may include information received through career verification, educational background verification, license verification, etc., from the server 100. For example, the digital card user interface 300 may include the user's employer information 310 (e.g., a previous employer card for Samsung Electronics, a previous employer card for Hyundai Motor Company). In another example, the digital card user interface 300 may include the user's educational background information (e.g., university graduation, graduate school graduation, etc.) and the user's license information (e.g., lawyer license, patent attorney certificate, etc.).

In one embodiment, the digital card user interface 300 may include a career card issuance user interface 320. Here, when the user terminal 200 detects an interaction with the career card issuance user interface 320, the user terminal 200 may display an identity authentication user interface 340 on the screen, as shown in FIG. 3B.

According to various embodiments, the identity authentication user interface 340 may include certification data 350 to be issued and a career verification request interface 360. Here, the certification data 350 to be issued may be data issued by national or public institutions (e.g., Certificate of Eligibility Record for Health Insurance, National Pension Subscription Certificate, W-2 forms issued by the U.S. Internal Revenue Service (IRS), etc.).

According to various embodiments, if the user terminal 200 detects an interaction with the career verification request interface 360, the user terminal 200 may perform identity authentication for the user who requested the career verification. For example, the user terminal 200 may perform a procedure to determine whether the entity requesting the career verification is the user by using various identity authentication technologies (e.g., ID and password input, SMS verification, accredited certificates, joint certificates, biometric authentication, resident registration number verification, social security number verification, etc.). In another example, the user terminal 200 may request the server 100 to authenticate the identity of the user requesting the career verification.

As shown in FIG. 3B, after the identity authentication is completed, the server 100 may provide career verification information for the user to the user terminal 200 based on at least one certification data (e.g., Certificate of Eligibility Record for Health Insurance, National Pension Subscription Certificate, etc.).

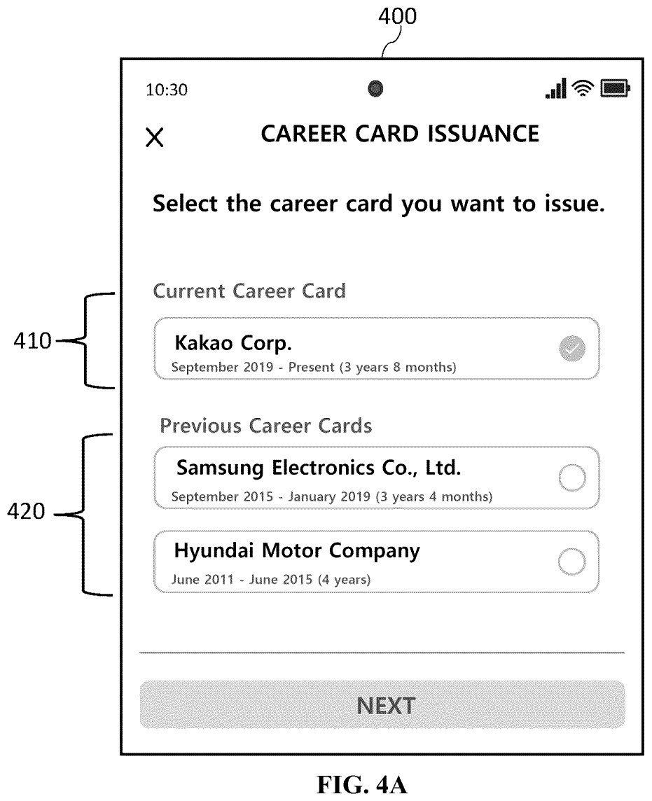

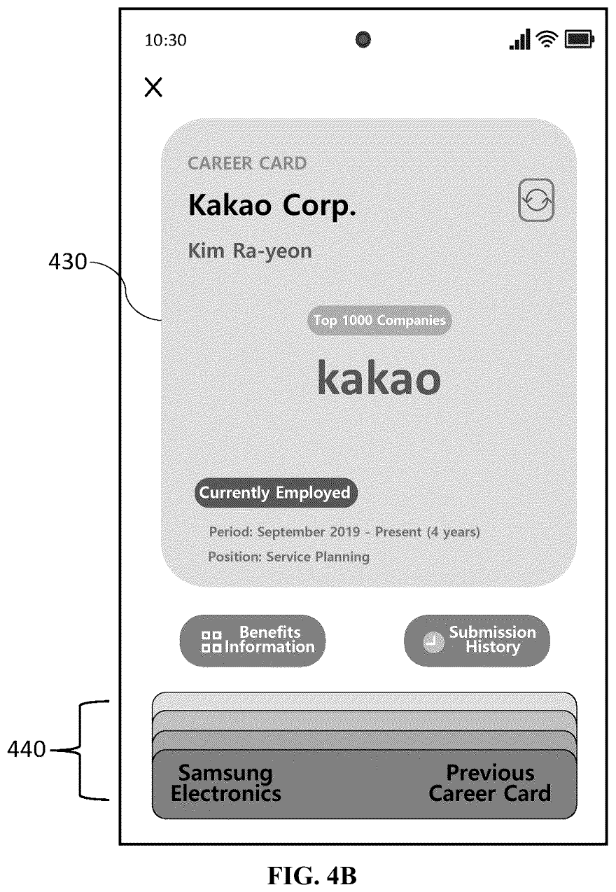

FIGS. 4A and 4B are diagrams illustrating examples in which a user terminal 200 displays a user interface corresponding to career verification information according to an embodiment of the present disclosure.

According to various embodiments, the user terminal 200 may receive career verification information for a user from a server 100. Referring to FIG. 4A, the user terminal 200 may display a career card user interface 400 on a screen of the user terminal 200 so that a user interface (e.g., employee card) corresponding to the career verification information received from the server 100 can be selected to issue. In one embodiment, the career card user interface 400 may include current employer information 410 (e.g., Kakao Corp. from September 2019 to present (3 years and 8 months)) and previous employer information 420 (e.g., Samsung Electronics Co., Ltd. from September 2015 to January 2019 (3 years and 4 months), and Hyundai Motor Company from June 2011 to June 2015 (4 years)).

Referring to FIG. 4B, the user terminal 200 may display the user interface corresponding to the career verification information on the screen of the user terminal 200. In one embodiment, the user terminal 200 may display a current employer user interface 430 and a previous employer user interface 440 on the user terminal 200.

The current employer user interface 430 may include information about the user's current employer, employment status, employment period, job position information, etc. The previous employer user interface 440 may include information about the user's previous employers, employment periods, job position information, etc. If the user has worked for multiple companies, the previous employer user interface 440 may be displayed as separate user interfaces corresponding to the respective companies.

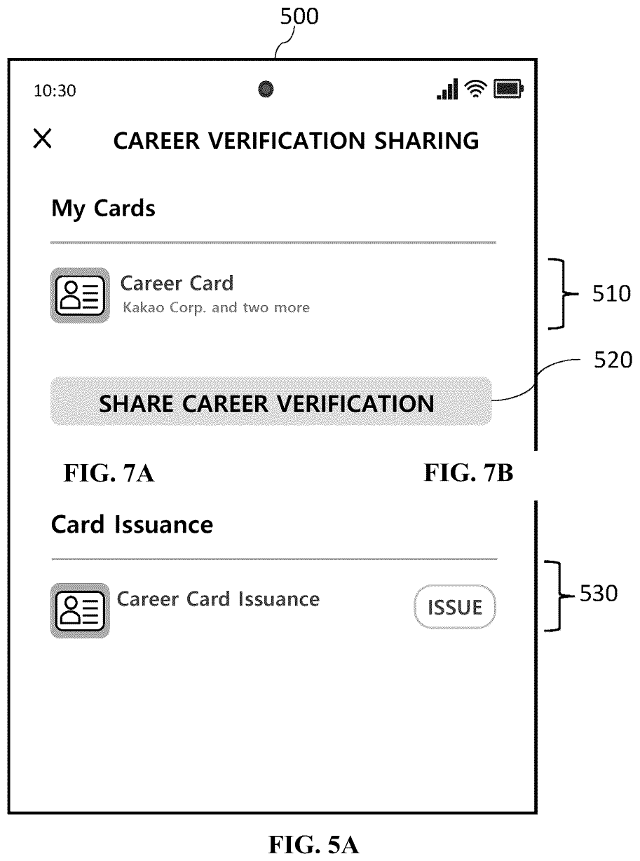

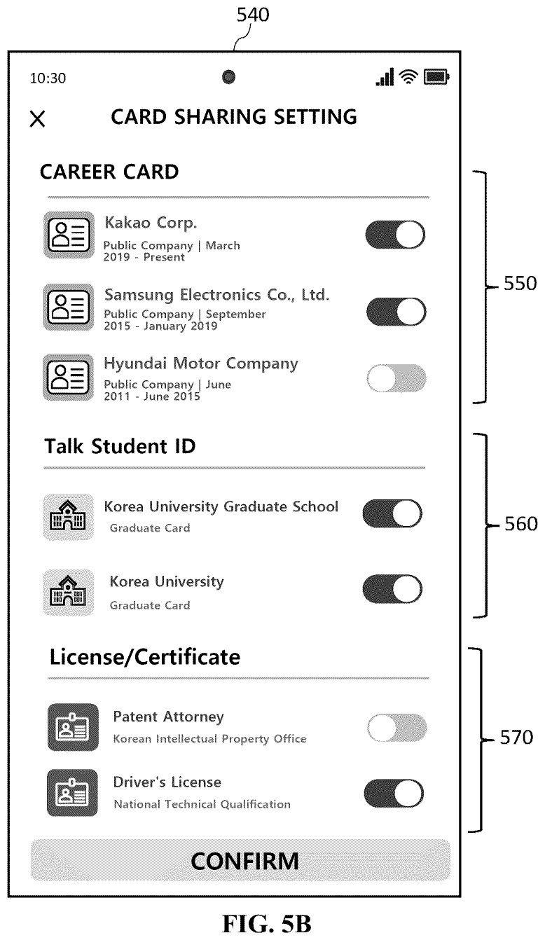

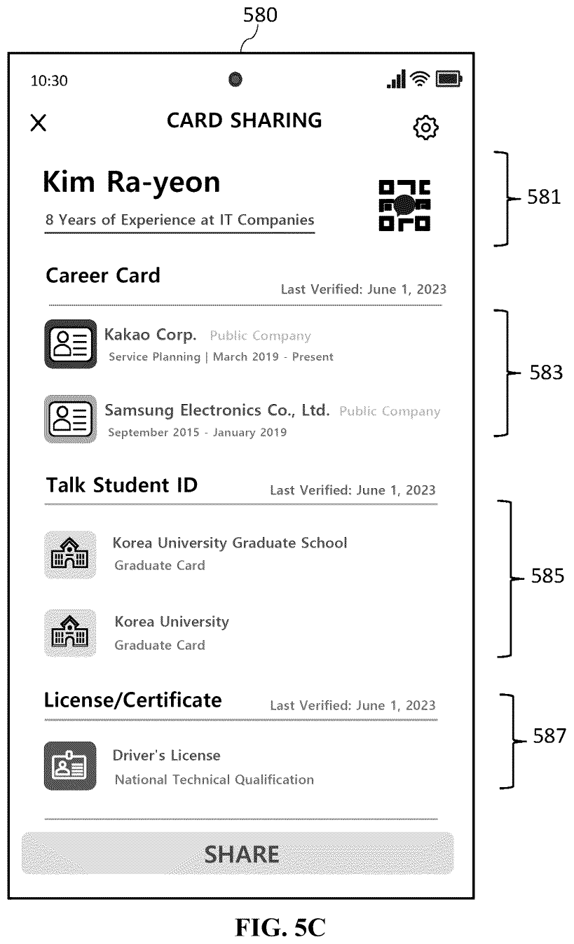

FIGS. 5A to 5C are diagrams illustrating an example in which a user terminal 200 shares a user interface corresponding to career verification information, according to an embodiment of the present disclosure.

According to various embodiments, the user terminal 200 may display a career verification interface 500 on a screen of the user terminal 200. The career verification interface 500 may include a career verification user interface 510, a career verification sharing interface 520, and a career card issuance user interface 530.

In one embodiment, the career verification user interface 510 may include information about career cards currently held by a user. For example, as shown in FIG. 4A, the user terminal 200 may store and display career cards corresponding to the user's current employer information, such as ‘Kakao Corp.,’ and previous employer information, such as ‘Samsung Electronics Co., Ltd.’ and ‘Hyundai Motor Company.’

In one embodiment, when the user terminal 200 receives an interaction with the career verification sharing interface 520, the user terminal 200 may provide a related functionality to transmit the user's career verification information to a third party through an application (e.g., a messenger application), SMS, or QR code.

The career card issuance user interface 530 substantially corresponds to the career card issuance user interface 320 of FIG. 3A, so a detailed description thereof will be omitted. For example, when the user terminal 200 verifies an interaction with the career card issuance user interface 530, the user terminal 200 may display a user interface (e.g., a career card) corresponding to the career verification information on the screen of the user terminal 200, as described with reference to FIGS. 3B to 4B.

FIG. 5b illustrates an example in which the card sharing interface 540 is displayed on the screen of the user terminal 200 when the user terminal 200 receives an interaction with the career verification sharing interface 520 according to various embodiments. The card sharing interface 540 may include a career card interface 550, an academic card interface 560, and a license card interface 570.

In one embodiment, the career card interface 550 may include the career cards currently held by the user of the user terminal 200 and a user interface for selecting whether to share each career card with a third party. For example, the career card interface 550 may include a current employer career card (e.g., Kakao Corp.) and previous employer career cards (e.g., Samsung Electronics Co., Ltd. and Hyundai Motor Company) of the user terminal 200. In such an example, the user terminal 200 may receive an interaction regarding whether to share each career card with a third party.

In one embodiment, the academic card interface 560 may include academic cards currently held by the user of the user terminal 200 (e.g., university, graduate school, etc.) and a user interface regarding whether to share each academic card with a third party. For example, the academic cards currently held by the user may be generated by the server 100 or the user terminal 200 based on graduation certificates or the like submitted or uploaded by the user terminal 200.

In one embodiment, the license card interface 570 may include license cards currently held by the user of the user terminal 200 (e.g., patent attorney certificate, driver's license, etc.) and a user interface regarding whether to share each license card with a third party. For example, the license cards currently held by the user may be generated by the server 100 or the user terminal 200 based on certificates or the like submitted or uploaded by the user terminal 200.

Referring to FIG. 5C, the user terminal 200 may display a card sharing interface 580 on the screen of the user terminal 200. The card sharing interface 580 may be generated based on interactions with the career card interface 550, academic card interface 560, and license card interface 570, as shown in FIG. 5B.

The card sharing interface 580 may include a user status information interface 581, career card information interface 583, educational background information interface 585, and license information interface 587. The user status information interface 581 may include a user's legal name (e.g., Ra-yeon Kim), the user's associated authentication information (e.g., 8 years of experience at IT companies), and a QR code.

In one embodiment, the user's associated verification information may be automatically generated based on career verification information (e.g., Samsung Electronics Co., Ltd. and Kakao Corp.) selected by the user terminal 200. For example, if the user's career information includes Samsung Electronics Co., Ltd. and Kakao Corp., with a total employment duration of 8 years across both companies, the server 100 or the user terminal 200 may generate associated verification information such as ‘8 years of experience at IT companies.’

In another embodiment, the user's associated verification information may be generated based on an interaction on the user terminal 200. For example, the user terminal 200 may receive an interaction of inputting associated verification information such as ‘4 years of experience at media companies’ or ‘9 years of experience in legal field.’

The career card information interface 583, educational background information interface 585, and license information interface 587 may be displayed based on interactions with the corresponding career card interface 550, academic card interface 560, and license card interface 570, as shown in FIG. 5B.

The user terminal 200 may provide information included in the card sharing interface 580 to a third party (e.g., a government agency, a public institution, a bank, an online platform, a chat room in a messenger application, an operator of an open chat room in the messenger application) in the form of an URL, a QR code, etc.

For example, a user account of the user terminal 200 that has signed up to a messenger application may share the card sharing interface 580 with another user account through a chat room in the messenger application. In another example, the user terminal 200 may transmit the card sharing interface 580 to a third party via a Short Message Service (SMS). In such cases, the third party (e.g., another user account, any other user terminal, etc.) may view the career verification information of the user (e.g., previous employer information, current employer information, etc.) included in the card sharing interface 580.

In yet another example, a QR code corresponding to the card sharing interface 580 may be generated by the server 100 or the user terminal 200. In such an example, if the QR code is scanned by the user terminal 200 or another user terminal, the card sharing interface 580 included in the QR code may be accessed.

In another embodiment, when the user terminal 200 shares the card sharing interface 580 with a third party (e.g., another user terminal, a government agency, a public institution, a bank, etc.), a period during which the third party can view the card sharing interface 580 may be limited. For example, the user terminal 200 may set a specific time limit (e.g., 10 minutes, 1 hour, 2 hours, etc.) for the third party to view the card sharing interface 580. In another example, the server 100 may automatically set a period during which the third party can view the card sharing interface 580.

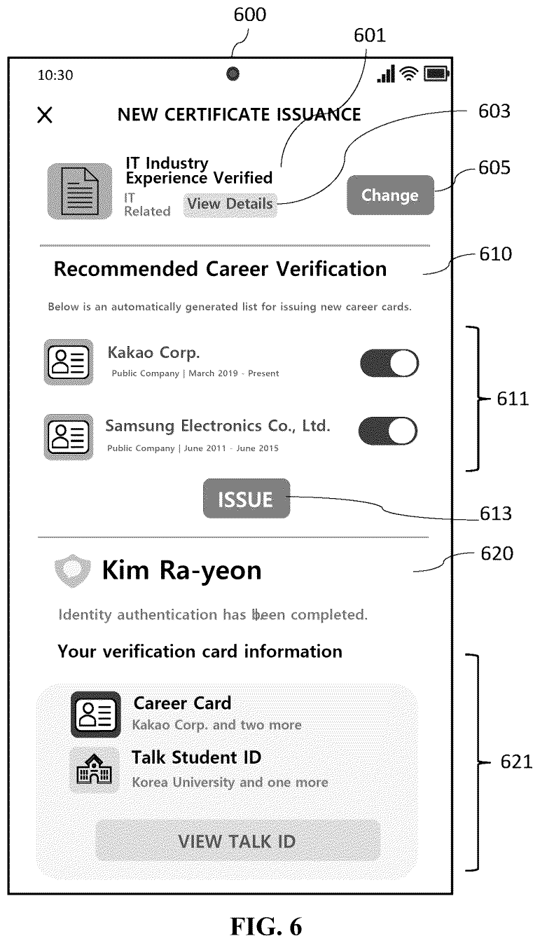

FIG. 6 is a diagram illustrating an example of generating associated verification information according to an embodiment of the present disclosure.

According to various embodiments of the present disclosure, a user terminal 200 may display a new career card issuance interface 600 on a screen of the user terminal 200.

In one embodiment, the new career issuance interface 600 may include associated verification information 601, an associated verification information category 603, and a change interface 605. The associated verification information 601 may be new verification information that the user wishes to issue based on career verification information of the user terminal 200. For example, the user terminal 200 may request the issuance of the associated verification information 601, such as IT industry experience verified, medical and health industry experience verified, and legal work experience verified.

When the user terminal 200 detects an interaction with the associated verification information category 603, the user terminal 200 may display category information (e.g., professions and job positions included in the IT industry) related to the associated verification information 601 on the screen of the user terminal 200. For example, the IT industry may include career information for job positions such as software developers, network engineers, data analysts, and security experts, while the education industry may include career information for job positions such as teachers, librarians, and education administrators.

When the user terminal 200 detects an interaction with the change interface 605, the user terminal 200 may allow the user to change the associated verification information 601, which the user wishes to issue, to different associated verification information. For example, the user terminal 200 may change ‘IT industry experience verified’ displayed in one area of the user terminal 200 to ‘finance industry experience verified,’ ‘engineering industry experience verified,’ etc. In this case, when the user terminal 200 wishes a change to different work experience verified, the associated verification information 601 may be changed to verified work experience (e.g., finance industry experience verified, engineering industry experience verified, etc.) selected by the user terminal 200.

In one embodiment, the new career issuance interface 600 may include a recommended career verification area 610. The recommended career verification area 610 may include recommended career information 611 for generating associated verification information 601 from the career verification information currently verified by the user terminal 200. The recommended career information 611 may be determined based on whether industry information included in the associated verification information 601 matches the career verification information verified by the user terminal 200. For example, the server 100 may determine if the industry information included in the associated verification information 601 matches the verified career verification information based on information such as business registration details (e.g., business type, item) and industry classification information according to preset categories (e.g., Korean Industrial Classifications).

For example, for ‘IT industry experience verified,’ the server 100 or the user terminal 200 may identify career verification information regarding multiple previous and current employers, including Kakao Corp. and Samsung Electronics Co., Ltd., which are part of the IT industry. For ‘IT industry experience verified’, the server 100 or user terminal 200 may automatically recommend current employer verification information (e.g., Kakao Corp.) and previous employer verification information (e.g., Samsung Electronics Co., Ltd.).

In another example, as participation conditions for an open chat room in a messenger application, specific career verification information (e.g., First IT Company, First Media Company) and academic verification information (e.g., graduation from a Korean university, graduation from A University in Korea, graduation from A University in Japan) may be set. Here, the open chat room is an online space where users with specific topics or interests can freely chat and share information. Unlike regular chat rooms, open chat rooms may allow chatting with other user accounts without verifying or sharing personal information (e.g., identification information, phone number information, etc.).

In such an example, the server 100 or the user terminal 200 may generate associated verification information for a user of the user terminal 200 to meet the participation conditions for the open chat room. For example, if the participation conditions for an open chat room in a messenger application are ‘graduation from Korean university’ and ‘First IT Company,’ the user terminal 200 may request to generate associated verification information to meet the aforementioned participation conditions. In this case, the user terminal 200 may display ‘graduation from Korean university +First IT Company’ as the associated verification information 601 and show the academic and career information currently verified by the user terminal 200 as recommended career information 611.

The server 100 or the user terminal 200 may automatically identify the current employment information and educational background information, which has been verified by the user terminal 200, to generate associated verification information such as verification of ‘Graduated from Korean University +First IT Company’. The server 100 may provide a functionality for the user terminal 200 so that recommended career verification information, educational background information, and/or license information are displayed in the recommended career verification area 610.

In another example, specific career verification information, educational verification information, and/or license verification information may be set as a participation condition in an online platform (e.g., employee shopping mall, employee-exclusive events, etc.). In this case, the server 100 or the user terminal 200 may generate associated verification information for the user of the user terminal 200 to meet the participation condition of the online platform. The server 100 or the user terminal 200 may automatically identify and recommend current employer information and license information, which are verified by the user terminal 200, to generate associated verification information such as verification of ‘First IT Company+Patent Attorney Certificate.’ The server 100 may provide a functionality for the user terminal 200 so that recommended career verification information, educational background information, and/or license information are displayed in the recommended career verification area 610.

In one embodiment, the user terminal 200 may generate associated verification information (e.g., IT industry experience verified) based on an interaction with each employer information included in the recommended career verification area 610. In another embodiment, the user terminal 200 may request the server 100 to generate associated verification information (e.g., IT industry experience verified) based on an interaction with each employer information included in the recommended career verification area 610.

For example, the server 100 or the user terminal 200 may determine whether ‘Kakao Corp.’ and ‘Samsung Electronics Co., Ltd.’ are part of the IT industry and may generate a user interface corresponding to the ‘IT industry experience verified’ as a new user interface (e.g., career card).

In one embodiment, a verification card area 620 may include information 621 on cards currently held by the user terminal 200. For example, the verification card area 620 may include a user interface corresponding to career card information (e.g., career card) and a user interface corresponding to educational background information (e.g., Talk Student ID) of the user of the user terminal 200.

According to one embodiment of the present disclosure, by providing career verification information of a user and a user interface corresponding to the career verification information, it is possible to efficiently and conveniently perform career verification for the user.

According to one embodiment of the present disclosure, by providing user interfaces corresponding to the multiple career verification information of the user, it is possible to efficiently and conveniently perform career verification for the user's previous and current employment.

According to one embodiment of the present disclosure, when career information of the user is updated due to a job change, the updated career verification information and the user interface corresponding to the career verification information may be provided, allowing verification and management of the user's work experience in real time.

At least part of the devices (e.g., modules or functions thereof) or methods (e.g., operations) according to various embodiments may be implemented with instructions as programming modules that are stored in computer-readable storage media. In one embodiment, an instruction, when executed by a processor (e.g., the processor 110, the processor 210, etc.), may cause one or more processors to perform functions corresponding to the instruction. The computer-readable storage medium may be, for example, a memory (e.g., the memory 120 or memory 250).

For example, the computer-readable recording medium may include various storage devices such as a hard disk, a floppy disk, magnetic media (e.g., magnetic tape), optical media (e.g., CD-ROM, DVD, magneto-optical media (e.g., floppy disk)), hardware devices (e.g., ROM, RAM, flash memory), and the like. In addition, examples of program instructions may include machine code instructions created by assembly languages, such as a compiler, and code instructions created by a high-level programming language executable in computers using an interpreter, etc. The described hardware devices may be configured to act as one or more software modules in order to perform the operations and methods described above, or vice versa.

The technical features disclosed in each embodiment of the present disclosure are not limited to a corresponding embodiment, and unless incompatible with each other, the technical features disclosed in each embodiment may be applied in combination to other embodiments.

Therefore, although each embodiment is described mainly about an individual technical feature, the technical features of the embodiments of the present disclosure may be applied in combination, unless incompatible with each other.

The present disclosure is not limited to the above-described embodiments and the accompanying drawings, and various modifications and changes may be made in view of a person skilled in the art to which the present disclosure pertains. Therefore, the scope of the present disclosure should be determined by the scope of the appended claims and equivalents thereof.

What is claimed is:

1. A method for providing career verification information by a server, the method comprising:
receiving a career verification request for a user from a user terminal;
in response to the career verification request, identifying at least one certification data including career information of the user;
identifying career information for the user based on the at least one identified certification data; and
in response to the identified career information comprising a plurality of career information, providing career verification information for the user to the user terminal so that user interfaces corresponding to each of the plurality of career information are displayed distinctly on the user terminal.

2. The method of claim 1, wherein the at least one certification data is data including at least one of the user's employment information, income information, and company information. 3 The method of claim 1, wherein the career verification information for the user comprises at least one of the following: name information, work experience information, employment status information, and job position information of the user.

4. The method of claim 1, further comprising:
identifying updates to the career information for the user; and
providing career update verification information for the user to the user terminal so that a user interface corresponding to the updated career information is displayed on the user terminal.

5. The method of claim 1, further comprising
generating associated verification information for the user based on the career information for the user; and
providing the generated associated verification information to the user terminal.

6. The method of claim 5, wherein the generating of the associated verification information for the user comprises:
receiving a request to generate associated verification information for the user from the user terminal;
categorizing the career information for the user according to preset categories; and
generating associated verification information for the user based on the categorized career information.

7. The method of claim 5, wherein the generating of the associated verification information for the user comprises:
identifying additional requirement information for generating the associated verification information;
transmitting the identified additional requirement information to the user terminal; and
in response to receiving the identified additional requirement information from the user terminal, generating associated verification information for the user.

8. The method of claim 7, wherein the additional requirements information comprises information that certifies at least one of educational background information, license information, and facility access permit information for the user.

9. A server providing career verification information, the server comprising:
a memory storing instructions, and
a processor configured to execute the instructions to:
receive a career verification request for a user from a user terminal;
in response to the career verification request, identify at least one certification data including career information of the user;
identify career information for the user based on the at least one identified certification data; and
in response to the identified career information comprising a plurality of career information, provide career verification information for the user to the user terminal so that user interfaces corresponding to each of the plurality of career information are displayed distinctly on the user terminal.

10. A method of providing career verification information by a user terminal, the method comprising:
transmitting a career verification request for a user to a server;
receiving career verification information for the user from the server, wherein the career verification information is generated based on at least one certification data including career information for the user; and
displaying a user interface corresponding to the received career verification information on a screen of the user terminal, wherein when the career information comprises a plurality of career information, user interfaces corresponding to each of the plurality of career information are displayed distinctly on the user terminal.

11. The method of claim 10, wherein the at least one certification data is data including at least one of the user's employment information, income information, and company information,

12. The method of claim 10, wherein the career verification information for the user comprises at least one of the following: name information, work experience information, employment status information, and job position information of the user.

13. The method of claim 10, further comprising:
identifying updates to the career information for the user; and
displaying a user interface corresponding to the updated career information on the screen of the user terminal.

14. The method of claim 10, further comprising:
requesting to generate associated verification information for the user from the server;
receiving associated verification information from the server; and
displaying a user interface corresponding to the received associated verification information on the screen of the user terminal.

15. The method of claim 14, wherein the receiving of the associated verification information from the server comprises:
receiving additional requirement information for generating the associated verification information from the server; and
transmitting the additional requirement information to the server.

16. The method of claim 15, wherein the additional requirements information comprises at least one of educational background information, license information, and facility access permit information for the user.
